(19) United States
(12) Patent Application Publication
(10) Pub. No.: US 2018/0114264 A1
(43) Pub. Date: Apr. 26, 2018

(54) SYSTEMS AND METHODS FOR CONTEXTUAL THREE-DIMENSIONAL STAGING

(71) Applicant: Aquifi, Inc., Palo Alto, CA (US)

(72) Inventors: Abbas Rafii, Palo Alto, CA (US); Carlo Dal Mutto, Sunnyvale, CA (US); Tony Zuccarino, Saratoga, CA (US)

(21) Appl. No.: 15/792,655

(22) Filed: Oct. 24, 2017

Related U.S. Application Data
(60) Provisional application No. 62/412,075, filed on Oct. 24, 2016.

(51) Int. Cl. G06Q 30/06; G06T 17/00; G06T 15/50

(52) U.S. Cl. CPC G06Q 30/0643; G06T 15/50; G06T 17/00

(57) ABSTRACT

A method for staging a three-dimensional model of a product for sale includes: obtaining, by a processor, a virtual environment in which to stage the three-dimensional model; loading, by the processor, the three-dimensional model from a collection of models of products for sale by a retailer, the three-dimensional model including model scale data; staging, by the processor, the three-dimensional model in the virtual environment to generate a staged virtual scene; rendering, by the processor, the staged virtual scene; and displaying, by the processor, the rendered staged virtual scene.

### CROSS-REFERENCE TO RELATED APPLICATION(S)

This application claims the benefit of U.S. Provisional Patent Application No. 62/412,075, filed in the United States Patent and Trademark Office on Oct. 24, 2016, the entire disclosure of which is incorporated by reference herein.

### FIELD

Aspects of embodiments of the present invention relate to the field of displaying three-dimensional models, including the arrangement of three-dimensional models in a computerized representation of a three-dimensional environment.

### BACKGROUND

In many forms of electronic communication, it is difficult to convey, immediately and intuitively, information about size and scale of physical objects. While there are various platforms allowing for the display of virtual three-dimensional environments that can give a sense of size and scale, the availability of these systems is often limited to use with special additional hardware and/or software. On the other hand, the display of two-dimensional images is widespread.

For example, in the context of electronic commerce or e-commerce, sellers may provide potential buyers with electronic descriptions of products available for sale. The electronic retailers may deliver the information on a website accessible over the internet or via a persistent data storage medium (e.g., flash memory or optical media such as a CD, DVD, or Blu-ray). Because the shoppers on traditional e-commerce site have to make a purchase decision without actually touching, feeling, lifting, and inspecting the merchandise in a close-up and in-person situation, the electronic retailers typically provide two-dimensional (2D) images as part of the listing information of the product in order to assist the user in evaluating the merchandise, along with text descriptions that may include the dimensions and weight of the product.

### SUMMARY

Aspects of embodiments of the present invention relate to systems and methods for the contextual staging of models within a three-dimensional environment.

According to one embodiment of the present invention, a method for staging a three-dimensional model of a product for sale includes: obtaining, by a processor, a three-dimensional environment in which to stage the three-dimensional model, the three-dimensional environment including environment scale data; loading, by the processor, the three-dimensional model of the product for sale from a collection of models of products for sale by a retailer, the three-dimensional model including model scale data; matching, by the processor, the model scale data and the environment scale data; staging, by the processor, the three-dimensional model in the three-dimensional environment in accordance with the matched model and environment scale data to generate a three-dimensional scene; rendering, by the processor, the three-dimensional scene; and displaying, by the processor, the rendered three-dimensional scene.

The three-dimensional model may include at least one light source, and the rendering the three-dimensional scene may include lighting at least one surface of the three-dimensional environment in accordance with light emitted from the at least one light source of the three-dimensional model.

The three-dimensional model may include metadata including staging information of the product for sale, and the staging the three-dimensional model may include deforming at least one surface in the three-dimensional scene in accordance with the staging information and in accordance with an interaction between the three-dimensional model and the three-dimensional environment or another three-dimensional model in the three-dimensional scene.

The three-dimensional model may include metadata including rendering information of the product for sale, the rendering information including a plurality of bidirectional reflectance distribution function (BRDF) properties, and the method may further include lighting, by the processor, the three-dimensional scene in accordance with the bidirectional reflectance distribution function properties of the model within the scene to generate a lit and staged three-dimensional scene.

The method may further include: generating a plurality of two-dimensional images based on the lit and staged three-dimensional scene; and outputting the two-dimensional images.

The three-dimensional model may be generated by a three-dimensional scanner including: a first infrared camera; a second infrared camera having a field of view overlapping the first infrared camera; and a color camera having a field of view overlapping the first infrared camera and the second infrared camera.

The three-dimensional environment may be generated by a three-dimensional scanner including: a first infrared camera; a second infrared camera having a field of view overlapping the first infrared camera; and a color camera having a field of view overlapping the first infrared camera and the second infrared camera.

The three-dimensional environment may be generated by the three-dimensional scanner by: capturing an initial depth image of a physical environment with the three-dimensional scanner in a first pose; generating a three-dimensional model of the physical environment from the initial depth image; capturing an additional depth image of the physical environment with the three-dimensional scanner in a second pose different from the first pose; updating the three-dimensional model of the physical environment with the additional depth image; and outputting the three-dimensional model of the physical environment as the three-dimensional environment.

The rendering the three-dimensional scene may include rendering the staged three-dimensional model and compositing the rendered three-dimensional model with a view of the scene captured by the color camera of the three-dimensional scanner

The selecting the three-dimensional environment may include: identifying model metadata associated with the three-dimensional model; comparing the model metadata with environment metadata associated with a plurality of three-dimensional environments; and identifying one of the three-dimensional environments having environment metadata matching the model metadata.

The method may further include: identifying model metadata associated with the three-dimensional model; comparing the model metadata with object metadata associated with a plurality of object models of the collection of models of products for sale by the retailer; identifying one of the object models having object metadata matching the model metadata; and staging the one of the object models in the three-dimensional environment.

The three-dimensional model may be associated with object metadata including one or more staging rules, and the staging the one of the object models in the three-dimensional environment may include arranging the object within the staging rules.

The model may include one or more movable components, the staging may include modifying the positions of the one or more movable components of the model, and the method may further include detecting a collision between: a portion of at least one of the one or more movable components of the model at at least one of the modified positions; and a surface of the three-dimensional scene.

The three-dimensional environment may be a model of a virtual store.

According to one embodiment of the present invention, a system includes: a processor; a display device coupled to the processor; and memory storing instructions that, when executed by the processor, cause the processor to: obtain a three-dimensional environment in which to stage a three-dimensional model of a product for sale, the three-dimensional environment including environment scale data; load the three-dimensional model of the product for sale from a collection of models of products for sale by a retailer, the three-dimensional model including model scale data; match the model scale data and the environment scale data; stage the three-dimensional model in the three-dimensional environment in accordance with the matched model and environment scale data to generate a three-dimensional scene; render the three-dimensional scene; and display the rendered three-dimensional scene on the display device.

The three-dimensional model may include at least one light source, and the memory may further store instructions that, when executed by the processor, cause the processor to render the three-dimensional scene by lighting at least one surface of the three-dimensional environment in accordance with light emitted from the at least one light source of the three-dimensional model.

The three-dimensional model may include metadata including staging information of the product for sale, and the memory may further store instructions that, when executed by the processor, cause the processor to stage the three-dimensional model by deforming at least one surface in the three-dimensional scene in accordance with the mass and in accordance with an interaction between the three-dimensional model and the three-dimensional environment or another three-dimensional model in the three-dimensional scene.

The three-dimensional model may include rendering information of the product for sale, the rendering information including a plurality of bidirectional reflectance distribution function (BRDF) properties, and wherein the memory may further store instructions that, when executed by the processor, cause the processor to light the three-dimensional scene in accordance with the bidirectional reflectance distribution function properties of the model within the scene to generate a lit and staged three-dimensional scene.

The system may further include a three-dimensional scanner coupled to the processor, the three-dimensional scanner including: a first infrared camera; a second infrared camera having a field of view overlapping the first infrared camera; and a color camera having a field of view overlapping the first infrared camera and the second infrared camera.

The memory may further store instructions that, when executed by the processor, cause the processor to generate the three-dimensional environment by controlling the three-dimensional scanner to: capture an initial depth image of a physical environment with the three-dimensional scanner in a first pose; generate a three-dimensional model of the physical environment from the initial depth image; capture an additional depth image of the physical environment with the three-dimensional scanner in a second pose different from the first pose; update the three-dimensional model of the physical environment with the additional depth image; and output the three-dimensional model of the physical environment as the three-dimensional environment.

The memory may further store instructions that, when executed by the processor, cause the processor to render the three-dimensional scene by rendering the staged three-dimensional model and compositing the rendered three-dimensional model with a view of the scene captured by the color camera of the three-dimensional scanner

The model may include one or more movable components, and wherein the staging includes modifying the positions of the one or more movable components of the model, and the memory may further store instructions that, when executed by the processor, cause the processor to detect a collision between: a portion of at least one of the one or more movable components of the model at at least one of the modified positions; and a surface of the three-dimensional scene.

According to one embodiment of the present invention, a method for staging a three-dimensional model of a product for sale includes: obtaining, by a processor, a virtual environment in which to stage the three-dimensional model; loading, by the processor, the three-dimensional model from a collection of models of products for sale by a retailer, the three-dimensional model including model scale data; staging, by the processor, the three-dimensional model in the virtual environment to generate a staged virtual scene; rendering, by the processor, the staged virtual scene; and displaying, by the processor, the rendered staged virtual scene.

The method may further include capturing a two-dimensional view a physical environment, wherein the virtual environment is computed from the two-dimensional view of the physical environment.

The rendering the staged virtual scene may include rendering the three-dimensional model in the virtual environment, and the method may further include: compositing the rendered three-dimensional model onto the two-dimensional view of the physical environment; and displaying the composited three-dimensional model onto the two-dimensional view.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, together with the specification, illustrate exemplary embodiments of the present invention, and, together with the description, serve to explain the principles of the present invention.

FIG. 1 is a depiction of a three-dimensional virtual environment according to one embodiment of the present invention, in which one or more objects is staged in the virtual environment.

FIG. 2A is a flowchart of a method for staging 3D models within a virtual environment according to one embodiment of the present invention.

FIG. 2B is a flowchart of a method for obtaining a virtual 3D environment according to one embodiment of the present invention.

FIG. 3 is a depiction of an embodiment of the present invention in which different vases, speakers, and reading lights are staged adjacent one another in order to depict their relative sizes.

FIG. 4 illustrates one embodiment of the present invention in which a 3D model of a coffee maker is staged on a kitchen counter under a kitchen cabinet, where the motion of the opening of the lid is depicted using dotted lines.

FIG. 5A is a depiction of a user's living room as generated by performing a three-dimensional scan of the living room according to one embodiment of the present invention.

FIG. 5B is a depiction of a user's dining room as generated by performing a three-dimensional scan of the living room according to one embodiment of the present invention.

FIGS. 6A, 6B, and 6C are depictions of the staging, according to embodiments of the present invention, of products in scenes with items of known size.

FIGS. 7A, 7B, and 7C are renderings of a 3D model of a shoe with lighting artifacts incorporated into the textures of the model.

FIGS. 8A, 8B, 9A, and 9B are renderings of a 3D model of a shoe under different lighting conditions, where bidirectional reflectance distribution function (BRDF) is stored in the model, and where modifying the lighting causes the shoe to be rendered differently under different lighting conditions.

FIG. 10 is a block diagram of a scanner system according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

As noted above, in many electronic commerce settings, the products available for sale are depicted by two-dimensional photographs, such as photographs of furniture and artwork displayed in an electronic catalog, which may be displayed in a web browser or printed paper catalog. However, in some instances, it may be difficult for a potential buyer to understand the size and shape of the product for sale based only on the two-dimensional images provided by the seller. Some sellers provide multiple views of the product in order to provide additional information about the shape of the object, where these multiple views may be generated by taking photographs of the product from multiple angles, but even these multiple views may fail to provide accurate information about the size of the object. A potential buyer or shopper would have significantly more information about the product if he or she was able to touch and manipulate the physical product, as is often possible when visiting a “brick and mortar” store.

Conveying information about the size and shape of a product in an electronic medium may be particularly important in the case of larger physical objects, such as furniture and kitchen appliances, and in the case of unfamiliar or unique objects. For example, a buyer may want to know if a coffee maker will fit on his or her kitchen counter, and whether there is enough clearance to open the lid of the coffee maker if it is located under the kitchen cabinets. As another example, a buyer may compare different coffee tables to consider how each would fit into the buyer's living room, given the size, shape, and color of other furniture such as the buyer's sofa and/or rug. In these situations, it may be difficult for the buyer to evaluate the products under consideration based alone on the photographs of the products for sale and the dimensions, if any, provided in the description.

As another example, reproductions of works of art may lack intuitive information about the relative size and scale of the individual pieces of artwork. While each reproduction may provide measurements (e.g., the dimensions of the canvas of a painting or the height of a statue), it may be difficult for a user to intuitively understand the significant difference in size between the “Mona Lisa” (77 cm×53 cm, which is shorter than most kitchen counters) and “The Last Supper” (460 cm×880 cm, which is much taller than most living room ceilings), and how those paintings might look in a particular environment, including under particular lighting conditions, and in the context of other objects in the environment (e.g., other paintings, furniture, and other customized objects).

In addition, on many large e-commerce websites, products are depicted in two-dimensional images. While these images may provide several points of view to convey more product information to the shopper, the images are typically manually generated by the seller (e.g., by placing the product in a studio and photographic the product from multiple angles, or photographed in a limited number of actual environments), which can be a labor-intensive process for the seller, and which still provide the consumer with a very limited amount of information about the product.

Aspects of embodiments of the present invention are directed to systems and methods for the contextual staging of three-dimensional (3D) models of objects within an environment and displaying those staged 3D models, thereby allowing viewer to develop a better understanding of how the corresponding physical objects would appear within a physical environment. In more detail, aspects of embodiments of the present invention relate systems and methods for generating synthetic composites of a given high definition scene or environment (part of a texture data collection) along with the corresponding pose of a 3D model of an object. This allows the system to generate a three-dimensional scene that can be used to generate views of the object, along with views of other objects that are contextually related, with proper occlusion by other objects in the scene, and also with proper global relighting of the objects (using model normal and or BRDF properties). When embodiments of the present invention are used in the field of e-commerce, this provides context for the products staged in such an environment, which can provide the shopper with an emotional connection with the product because there are related objects putting the object in the right context; and provides scale to convey to the shopper an intuition of the size of the product itself, and its size in relation to the other contextual scene hints and objects.

For example, in one embodiment of the present invention, a shopper or consumer would use a personal device (e.g., a smartphone) to perform a scan of their living room (e.g., using a depth camera), thereby generating a virtual, three-dimensional model of the environment of the living room. The personal device may then stage a three-dimensional model of a product (e.g., a couch) within the 3D model of the environment of the shopper's living room, where the 3D model of the product may be retrieved from a retailer of the product (e.g., a furniture retailer). In other embodiments of the present invention, the shopper or consumer may stage the 3D models within other virtual environments, such as a pre-supplied environment representing a kitchen.

According to some embodiments of the present invention, a 3D model is inserted into a synthetic scene based on an analysis of the scene and the detection of the location of the floor (or the ground plane), algorithmically deciding where to place the walls within the scene, and properly occluding all of the objects including the for sale item in the scene (because the system knows everything three-dimensional about the objects). In some embodiments of the present invention, at least some portions of the scene may be manually manipulated or arranged by a user (e.g., a seller or a shopper). In some embodiments, the system relights the staged scene using high-performance relighting technology such as 3D rendering engines used in video games.

As such, some embodiments of the present invention enable a shopper or customer to stage 3D models of products within a virtual environment of their choosing. Such embodiments convey a better understanding of the size and shape of the product within those chosen virtual environments, thereby increasing their confidence in their purchases and reducing the rate of returns due to unforeseen unsuitability of the products for the environment.

Some aspects of embodiments of the present invention are directed to accurate depictions of the size and scale of the products within the virtual environment, in addition to accurate depictions of the color and lighting of the products so staged within the virtual environment, thereby improving the confidence that a consumer may have in how the physical product will fit into the physical environments in which the consumer intends to arrange the products (e.g., whether a particular couch will fit into a room without blocking or restricting movement through the room).

Contextual 3D Model Staging

Aspects of embodiments of the present invention are directed to systems and methods for the contextual staging of three-dimensional models. In more detail, aspects of embodiments of the present invention are directed to “staging” or arranging a three-dimensional model within a three-dimensional scene that contains one or more other objects. The three-dimensional model may be automatically generated from a three-dimensional scan of a physical object. Likewise, the three-dimensional scene or environment may also be automatically generated from a three-dimensional scan of a physical environment. In some embodiments of the present invention, two-dimensional views of the object can be generated from the staged three-dimensional scene.

In some embodiments of the present invention, the staging of three dimensional (3D) models assists in an electronic commerce system, in which shoppers may place 3D models of products that are available for purchase within a 3D environment, as rendered on a device operated by the shopper. For the sake of convenience, the shopper will be referred to herein as the “client” and the device operated by the shopper will be referred to as a client device.

Staging objects in a three-dimensional environment allows shoppers on e-commerce systems (such as websites or stand-alone applications) to augment their shopping experiences by interacting with 3D models of the products they seek using their client devices. This provides the advantage of allowing the shopper to manipulate the 3D model of the product in a life-like interaction, as compared to the static 2D images that are typically used to merchandise products online. Furthermore, accurate representations of the dimensions of the product in the 3D model (e.g., length, width, and height, as well as the size and shape of individual components) would enable users to interact with the model itself, in order to take measurements for aspects of the product model that they are interested in, such as the length, area, or the volume of the entire model or of its parts (e.g., to determine if a particular coffee maker would fit into a particular nook in the kitchen). Other forms of interaction with the 3D model may involve manipulating various moving parts of the model, such as opening the lid of a coffee maker, changing the height and angle of a desk lamp, sliding open the drawers of a dresser, spreading a tablecloth across tables of different sizes, moving the arms of a doll, and the like.

According to one embodiment of the present invention, a seller generates a set of images of a product for sale in which the product is staged within the context of other physical objects. For example, in the case of a coffee maker as described above, the seller may provide the user with a three-dimensional (3D) model of the coffee maker. The seller may have obtained the 3D model of the coffee maker by using computer aided design (CAD) tools to manually create the 3D model or by performing a 3D scan of the coffee maker. While typical 3D scanners are generally large and expensive devices that require highly specialized setups, more recent developments have made possible low-cost, handheld 3D scanning devices (see, e.g., U.S. Provisional Patent Application Ser. No. 62/268,312 “3D Scanning Apparatus Including Scanning Sensor Detachable from Screen,” filed in the U.S. Patent and Trademark Office on Dec. 16, 2015 and see U.S. patent application Ser. No. 15/147,879 “Depth Perceptive Trinocular Camera System,” filed in the United States Patent and Trademark Office on May 5, 2016) that bring 3D scanning technology to consumers for personal use, and to provide vendors with fast and economical techniques for 3D scanning.

A user may then use a system according to embodiments of the present invention to add the generated model to a scene (e.g., a three-dimensional model of a kitchen). Scaling information about the physical size of the object and the physical size the various elements of the scene are used to automatically adjust the scale of the object and/or the scene such that the two scales are consistent. As such, the coffee maker can be arranged on the kitchen counter of the scene (in both open and closed configurations) to more realistically show the buyer how the coffee maker will appear in and interact with an environment. As noted above, in some embodiments, the environment can be chosen by the shopper.

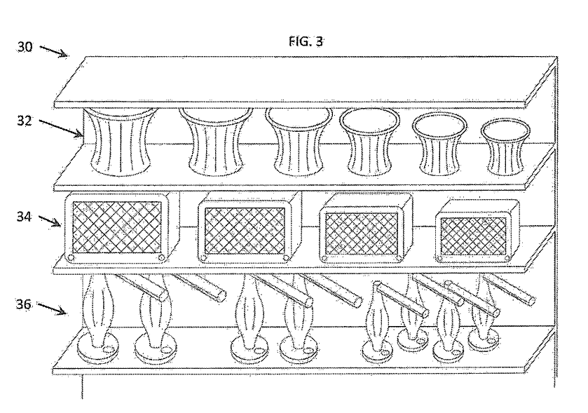

In various embodiments of the present invention, the client device is a computing system that includes a processor and memory, such as a smartphone, a tablet, a laptop computer, a tablet computer, a desktop computer, a dedicated device (e.g., including a processor and memory coupled to a touchscreen display and an integrated depth camera), and the like. In some embodiments of the present invention, the client device includes a depth camera system, as described in more detail below, for performing 3D scans. The client device includes components that may perform various operations and that may be integrated into a single unit (e.g., a camera integrated into a smartphone), or may be in separate units (e.g., a separate webcam connected to a laptop computer over a universal serial bus cable, or, e.g., a display device in wireless communication with a separate computing device). One example of such a client device is described below with respect to FIG. 4, which includes a host processor 108 that can be configured, by instructions stored in the memory 110 and/or the persistent memory 120, to implement various aspects of embodiments of the present invention.

In some embodiments of the present invention, the client device may include, for example, 3D goggles, headsets, augmented reality/virtual reality (AR/VR) or mixed reality goggles, retinal projectors, bionic contact lenses, or other devices to overlay images in the field of view of the user (e.g., augmented reality glasses or other head-up display systems such as Google Glass and Microsoft HoloLens, and handheld augmented reality systems, such as overlying images onto a real-time display of video captured by a camera of the handheld device). Such devices may be coupled to the processor in addition to, or in place of, the touchscreen display 114 shown in FIG. 4. In addition, the embodiments of the present invention may include other devices for receiving user input, such as a keyboard and mouse, dedicated hardware control buttons, reconfigurable “soft buttons,” three-dimensional gestural interfaces, and the like.

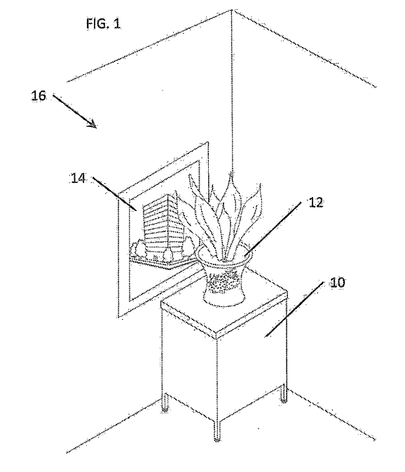

As a motivating example, FIG. 1 is a depiction of a three-dimensional virtual environment according to one embodiment of the present invention, in which one or more objects is staged in the virtual environment. Referring to FIG. 1, the consumer may be considering purchasing a corner table 10, but may also wonder if placing their vase 12 on the table would obscure a picture 14 hanging in the corner of the room. In particular, the dimensions and location of the painting, as well as the size of the vase, may be factors in choosing an appropriately sized corner table. As such, a consumer can stage a scene in based on the environment 16 in which the consumer is considering using the product.

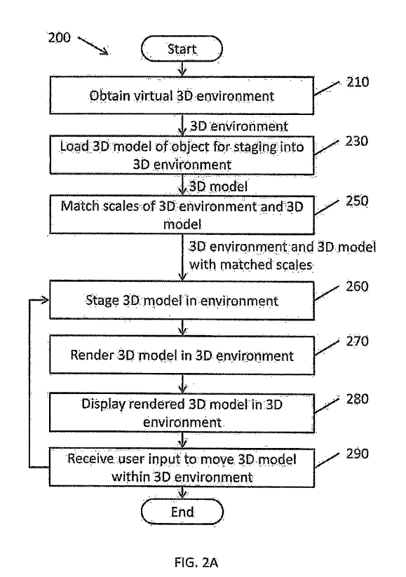

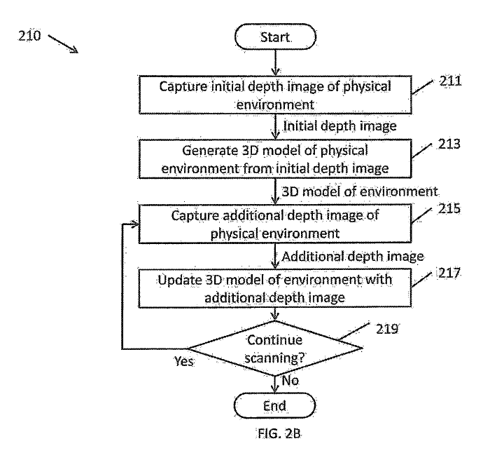

FIG. 2A is a flowchart of a method for staging models within a virtual environment according to one embodiment of the present invention.

In operation 210, the system obtains a virtual 3D environment into which the system will stage a 3D model of an object. The virtual 3D environment may be associated with metadata describing characteristics of the virtual 3D environment. For example, the metadata may include a textual description with keywords describing the room such as “living room,” “dining room,” “kitchen,” “bedroom,” “store”, and the like, as well as other characteristics such as “dark,” “bright,” “wood,” “stone,” “traditional,” “modern,” “mid-century,” and the like). The metadata may be supplied by the user before or after generating the 3D virtual environment by performing a scan (described in more detail below), or may be included by the supplier of the virtual 3D environment (e.g., when downloaded from a 3rd party source). The metadata may also include information about the light sources within the virtual 3D environment, such as the brightness, color temperature, and the like of each of the light sources (and these metadata may be configured when rendering a 3D scene). The virtual 3D environment may include a scale (e.g., an environment scale), which specifies a mapping between distances between coordinates in the virtual 3D environment and the physical world. For example, a particular virtual 3D environment may have a scale such that a length of 1 unit in the virtual 3D environment corresponds to 1 centimeter in the physical world, such that a model of a meter stick in the virtual world would have a length, in virtual world coordinates, of 100. The coordinates in the virtual environment need not be integral, and may also include portions of units (e.g., a 12-inch ruler in the virtual environment may have a length of about 30.48 units). In the case of FIG. 1, the virtual 3D environment 16 may include, for example, the shape of the corner of the room and the picture 14.

In some embodiments, the virtual 3D environment is obtained by scanning a scene using a camera (e.g., a depth camera), as described in more detail below with respect to FIG. 2B. FIG. 2B is a flowchart of a method for obtaining a virtual 3D environment according to one embodiment of the present invention. Referring to FIG. 2B, in operation 211 the system 100 captures an initial depth image of a scene. In one embodiment using a stereoscopic depth camera system, the system controls cameras 102 and 104 to capture separate images of the scene (either with or without additional illumination from the projection source 106) and, using these separate stereoscopic images, the system generates a depth image (using, for example, feature matching and disparity measurements as discussed in more detail below). In operation 213, an initial 3D model of the environment may be generated from the initial depth image, such as by converting the depth image into a point cloud. In operation 215, an additional depth image of the environment is captured, where the additional depth image is different from the first depth image, such as by rotating (e.g., panning) the camera and/or translating (e.g., moving) the camera.

In operation 217, the system updates the 3D model of the environment with the additional captured image. For example, the additional depth image can be converted into a point cloud and the point cloud can be merged with the existing 3D model of the environment using, for example, an iterative closest point (ICP) technique. For additional details on techniques for merging separate depth images into a 3D model, see, for example, U.S. patent application Ser. No. 15/630,715 “Systems and Methods for Scanning Three-Dimensional Objects,” filed in the United States Patent and Trademark Office on Jun. 22, 2017, the entire disclosure of which is incorporated herein by reference.

In operation 219, the system determines whether to continue scanning, such as by determining whether the user has supplied a command to terminate the scanning process. If scanning is to continue, then the process returns to operation 215 to capture another depth image. If scanning is to be terminated, then the process ends and the completed 3D model of the virtual 3D environment is output.

In some embodiments of the present invention, the physical environment may be estimated using a standard two-dimensional camera in conjunction with, for example, an inertial measurement unit (IMU) rigidly attached to the camera. The camera may be used to periodically capture images (e.g., in video mode to capture images at 30 frames per second) and the IMU may be used to estimate the distance and direction traveled between images. The distances moved can be used to estimate a stereo baseline between images and to generate a depth map from the images captured at different times.

In some embodiments of the present invention, the virtual 3D environment is obtained from a collection of stored, pre-generated 3D environments (e.g., a repository of 3D environments). These stored 3D environments may have been generated by scanning a physical environment using a 3D scanning sensor such as a depth camera (e.g., a stereoscopic depth camera or a time-of-flight camera), or may have been generated by a human operator (e.g., an artist) using a 3D modeling program, or combinations thereof (e.g., through the manual refinement of a scanned physical environment). A user may supply input to specify the type of virtual 3D environment that they would like to use. For example, a user may state that they would like a “bright mid-century modern living room” as the virtual 3D environment or a “modern quartz bathroom” as the virtual 3D environment, and the system may search for the metadata of the collection of virtual 3D environments for matching virtual 3D environments, then display one or more of those matches for selection by the user. In some embodiments, one or more virtual 3D environments are automatically identified based on the type of product selected by the user. For example, if the user selects a sofa as the model to be staged or makes a request such as “I would like a sofa for my living room,” then one or more virtual 3D environments corresponding to living rooms may be automatically selected for staging of the sofa.

Aspects of embodiments of the present invention relate to systems and methods for automatically selecting environments to compose with the object of interest. In some embodiments, the system automatically selects an environment from the collection of pre-generated 3D environments into which to stage the object. In the case where a user selects a pre-existing model of an object (e.g., a model of a product for sale), metadata associated with the product identifies one or more pre-generated 3D environments that would be appropriate for the object (e.g., a model of a hand soap dispenser includes metadata that associates the model with a bathroom environment as well as a kitchen environment).

In some instances, a user may perform a scan of a physical product that the user already possesses, and the system may automatically attempt to stage the scan of the object in an automatically identified virtual environment. For example, the model of the scanned object may be automatically identified by comparing to a database of models (see, e.g., U.S. Provisional Patent Application No. 62/374,598 “Systems and Methods for 3D Models Generation with Automatic Metadata,” filed on Aug. 12, 2016), and a scene can be automatically selected based on associated metadata. For example, a model identified as being a coffee maker may be tagged as being a kitchen appliance and, accordingly, automatically identify a kitchen environment to place the coffee maker into, rather than a living room environment or an office environment. This process may also be used to identify other models in the database that are similar. For instance, a user can indicate their intent to purchase a coffee maker by scanning their existing coffee maker to perform a search for other coffee makers, and then stage the results of the search in a virtual environment, potentially staging those results alongside the user's scan of their current coffee maker.

The metadata associated with a 3D model of an object may also include other staging and rendering information that may be used in the staging and rendering of model with an environment. The staging information includes information about how the model physically interacts with the virtual 3D environment and physically interacts with other objects in the scene. For example, the metadata may include staging information about the rigidity or flexibility of a structure at various points, such that the object can be deformed in accordance with placing loads on the object. As another example, the metadata may include staging information about the weight or mass of an object, that the flexion or deformation of the portion of the scene supporting the object can be depicted. The rendering information includes information about how the model may interact with light and lighting sources within the virtual 3D environment. As described in more detail below, the metadata may also include, for example, rendering information about the surface characteristics of the model, including one or more bidirectional reflectance distribution functions (BRDF) to capture reflectance properties of the surface of the object, as well as information about light sources of (or included as a part of) the 3D model of the object.

Some of these pre-generated environments may be considered “basic” environments while other environments may be higher quality (e.g., more detailed) and therefore may be considered “premium,” where a user (e.g., the seller or the shopper) may choose to purchase access to the “premium” scenes. In some embodiments, the environment may be provided by the user without charging a fee.

Returning to FIG. 2A, in operation 230, the system loads a 3D model of an object to be staged into the virtual 3D environment. In the case of FIG. 1, there may be two objects to be staged: the corner table 10 and the vase 12. The objects may be loaded from an external third-party source or may be an object captured by the user or consumer. In the case of FIG. 1, the corner table 10 that the consumer is considering purchasing may be loaded from a repository of 3D models of furniture that is provided by the seller of that corner table 10. On the other hand, the vase with the flower arrangement may already belong to the user, and the user may generate the 3D model of the vase 12 using the 3D scanning system 100, as described in more detail below in the section on scanner systems. Like the virtual 3D environment, the models of the 3D objects are also associated with corresponding scales (or model scales) that map between their virtual coordinates and a real-world scale. The scale (or model scale) associated with a 3D model of an object may be different from the scale of the 3D environment, because the models may have different sources (e.g., they may be generated by different 3D scanning systems, stored in different file formats, generated using different 3D modeling software, and the like).

In operation 250, the system matches the scales of the 3D environment and the object (or objects) such that the 3D environment and the models of the objects all have the same scale. For example, if the 3D environment uses a scale of 1 unit=1 cm and the 3D model of the object uses a scale of 1 unit=0.1 mm, then the system may scale the coordinates of the 3D model of the object by 100 such that the units of the 3D model of the object are the same as those of the virtual 3D environment.

In operation 260, the system stages the 3D model in the environment. The 3D model may initially be staged at a location within the scene within the field of view of the virtual camera from which the scene is rendered. In this initial staging, the object may be placed in a sensible location in which the bottom surface of the object is resting on the ground or supported by a surface such as a table. In the case of FIG. 1, the corner table 10 may be initially staged such that it is staged upright with its legs on the ground, and without any surfaces intersecting with the walls of the corner of the room. The vase 12, similarly, may initially be staged on the ground or, if the corner table 10 was staged first, the vase 12 may automatically be staged on the corner table in accordance with various rules (e.g., a rule that the vase should be staged on a surface if any, that is at least a particular height above the lowest surface in the scene).

In some aspects of embodiments of the present invention, the staging may also include automatically identifying related objects and placing the related objects into a scene, where these related models may provide additional context to the viewer. For example, coffee-related items such as a coffee grinder and coffee mugs may be placed in the scene near the coffee maker. Other kitchen appliances such as a microwave oven may also be automatically added to the scene. The related objects can be arranged near the object of interest, e.g., based on relatedness to the object (as determined, for example, by tags or other metadata associated with the object), as well as in accordance with other rules that are stored in association with the object (e.g., one rule may be that microwave ovens are always arranged on a surface above the floor, with the door facing outward and with the back flush against the wall).

In operation 270, the system renders the 3D model of the object within the virtual 3D environment using a 3D rendering engine (e.g., a raytracing engine) from the perspective of the virtual camera.

In operation 280, the system displays (e.g., on the display device 114) the 3D model of the object within 3D environment in accordance with scale and location of virtual camera. In some embodiments of the present invention, both the 3D model and the 3D environment are rendered together in a single rendering of the scene.

In some embodiments of the present invention, a mobile device such as a smartphone that is equipped with a depth camera (e.g., the depth perceptive trinocular camera system referenced above) can be used to scan a current environment to create a three-dimensional scene and, in real-time, place a three-dimensional model of an object within the scene. A view of the staged three-dimensional scene can then be displayed on the screen of the device and updated in real time based on which portion of the scene the camera is pointed at. In other words, the rendered view of the 3D model, which may be lit in accordance with light sources detected within the current environment, may be composited or overlaid on a live view of the scene captured by the cameras (e.g., the captured 3D environment may be hidden or not displayed on the screen and may merely be used for staging the product within the environment, and the position of the virtual camera in the 3D environment can be kept synchronized with the position of the depth camera in the physical environment, as tracked by, for example, the IMU 118 and based on feature matching and tracking between the view from a color camera of the depth camera and the virtual 3D environment). Because the depth camera can capture depth information about objects in the scene, embodiments of the present invention may also properly occlude portions of the rendered 3D model in accordance with other objects in a scene. For example, if a physical coffee table is located in the scene and a 3D model of a couch is virtually staged behind the coffee table, then, when the user views the 3D model of the couch using the system from a point of view where the coffee table is between the user and the couch, then portions of the couch will be properly occluded by the coffee table. This may be implemented by using the depth information about the depth of the coffee table within the staged environment in order to determine that the coffee table should occlude portions of the couch.

This technique is similar to “augmented reality” techniques, and further improves such techniques, as the depth camera allows more precise and scale-correct placement of the virtual objects within the image. In particular, because the models include information about scale, and because the 3D camera provides scale of the environment, the model can be scaled to look appropriately sized in the display, and the depth camera allows for the calculation of occlusions. The surface normals and bidirectional reflectance distribution function (BRDF) properties of the model can be used to relight the model to match the scene, as described in more detail below.

In some embodiments of the present invention, the 3D scene with the 3D model of the object staged within a 3D environment can be presented to the user through a virtual reality (VR) system, goggles or headset (such as HTC Vive®, Samsung Gear VR®, PlayStation VR®, Oculus Rift®, Google Cardboard®, and Google® Daydream®), thereby providing the user with a more immersive view of the product staged in an environment.

In operation 290, the system may receive user input to move the 3D model within the 3D environment. If so, then the 3D model may be re-staged within the scene in operation 260 and may be re-rendered in operation 270 in accordance with the updated location of the 3D model of the object. Users can manipulate the arrangement of the objects in the rendered 3D environment (including operating or moving various movable parts of the objects), and this arrangement may be assisted by the user interface such as by “snapping” 3D models of movable objects to flat horizontal surfaces (e.g., the ground or tables) in accordance with gravity, and by “snapping” hanging objects such as paintings to walls when performing the re-staging of the 3D model in the environment in operation 260. In some embodiments of the present invention, no additional props or fiducials are required to be placed in the scene detect these surfaces, because a virtual 3D model of the environment provides sufficient information to detect such surfaces as well as the orientations of the surfaces. For instance, acceleration information captured from the IMU during scanning can provide information about the direction of gravity and therefore allow the inference of whether various surfaces are horizontal (or flat or perpendicular to gravity), vertical (or parallel to gravity), or sloped (somewhere in between, neither perpendicular nor parallel to gravity). In one embodiment, the snapping of movable objects to flat horizontal surfaces by reducing or lowering the model of the object along the vertical axis until the object collides with another object or surface in the scene. Moreover, the object can be rotated in order to obtain the desired aligned configuration of the object within the environment. The relevant technology is made possible by using methods for aligning 3D objects with other objects, and within 3D space models under realistic rendering of lighting and with correct scale. The rotation of objects can likewise “snap” such that the various substantially flat surfaces can be rotated to be parallel or substantially parallel to surfaces in the scene (e.g., the back of a couch can be snapped to be parallel to a wall in the 3D environment). In one embodiment, snapping by rotation may include projecting a normal line from a planar surface of the 3D model (e.g., a line perpendicular to a plane along the side of the corner table 10) and determining if the projected normal line is close in angle (e.g., within a threshold angular range) to also being normal to another plane in the scene (e.g., a plane of another object or a plane of the 3D environment). If so, then object may be “snapped” to a rotational position where the projected line is also normal to the other surface in the scene. In some embodiments, the planar surface of the 3D model may be a fictional plane that is not actually a surface of the model (e.g., the back of a couch may be angled such that a normal line projected from it would point slightly downward, toward the floor, but the fictional plane of the couch may extend vertically and extend along a direction parallel to the length direction of the couch). Referring to FIG. 1, the user may rotate and move the model of the corner table 10 within the 3D environment 16, as assisted by the system, such that the sides of the corner table 10 “snap” against the walls of the corner of the room and such that the vase 12 snaps to the top surface of the corner table 10.

Furthermore, in some embodiments, the process of staging may be configured to prevent a user from placing the 3D model of the object into the 3D environment in a way such that its surfaces would intersect with (or “clip”) the other surfaces of the scene, including the surfaces of the virtual 3D environment or the surfaces of other objects placed into the scene. This may be implemented using a collision detection algorithm for detecting when two 3D models intersect and adjusting the location of the 3D models within the scene such that the 3D models do not intersect. For example, referring to FIG. 1, when staging the model of the corner table 10, the system may prevent the model of the corner table 10 from intersecting with the walls of the room (such that the corner table does not appear to unnaturally appear to be embedded within a wall), and also prevents the surfaces of the corner table 10 and the vase 12 from intersecting (e.g., such that the vase appears to rest on top of the corner table, rather than being embedded within the surface of the corner table).

In some embodiments, the combined three-dimensional scene of the product with an environment can be provided to the shoppers for exploration. This convergence of 3D models produced by shoppers of their personal environment with the 3D object models provided by the vendors, provides a compelling technological and marketing possibility to intimately customize a sales transaction. Furthermore, even if the shopper does not have a 3D model of their personal environment, as noted above, the merchant can provide an appropriate 3D context commensurate with the type of merchandise for sale. For example, a merchant selling television stands may provide a 3D environment of a living room as well as 3D models of televisions in various sizes so that a user can visualize the combination of the various models of television stands with various sizes of televisions in a living room setting.

In some embodiments of the present invention, the user interface also allows a user to customize or edit the three-dimensional scene. For example, multiple potential scenes may be automatically generated by the system, and the user may select one or more of these scenes (e.g., different types of kitchen scene designs). In addition, a variety of scenes containing the same objects, but in different arrangements, can be automatically and algorithmically generated in accordance with the rules associated with the objects. Continuing the above example, in a kitchen scene including a coffee maker, a coffee grinder, and mugs, the various objects may be located at various locations on the kitchen counter, in accordance with the placement rules for the objects (e.g., the mugs may be placed closer or farther from the coffee maker). Objects may be automatically varied in generating the scene (e.g., the system may automatically and/or randomly select from multiple different 3D models of coffee mugs). In addition, other objects can be included in or excluded from the automatically generated scenes in order to provide additional variation (e.g., the presence or absence of a box of coffee filters). The user may then select from the various automatically generated scenes, and may make further modifications to the scene (e.g., shifting or rotating individual objects in the scene). Furthermore, the automatically generated scenes can be generated such that each scene is significantly different from the other generated scenes, such that the user is presented with a wide variety of possibilities. Iterative learning techniques can also be applied to generate more scenes. For example, a user may select one or more of the automatically generated scenes based on the presence of desirable characteristics, and the system can algorithmically generate new scenes based on the characteristics of the user selected scenes. The user interface may also allow a user to modify parameters of the scene such as the light level, the light temperature, daytime versus nighttime, etc.

In addition, the user interface may be used to control the automatic generation of two-dimensional views of the three-dimensional scene. For example, the system may automatically generate front, back, left, right, top, bottom, and perspective views of the object of interest. In addition, the system may automatically remove or hide objects from the scene if they would occlude significant parts of the object of interest when automatically generating the views. The generated views can then be exported as standard two-dimensional images such as Joint Photographic Experts Group (JPEG) or Portable Network Graphics (PNG) images, as videos formats such as H.264, or as proprietary custom formats.

The user interface for viewing and editing the three-dimensional scene may be provided to the seller, the shopper, or both. For example, in some embodiments of the present invention, the user interface for viewing the scene can be provided so that the shopper can control the view and the arrangement of the object of interest within the three-dimensional scene. This can be contrasted with comparative techniques in which the shopper can only view existing generated views of the object, as provided by the seller. The user interface for viewing and controlling the three-dimensional scene can be provided in a number of ways, such as a web based application delivered via a web browser (e.g., implemented with web browser-based technologies such as JavaScript) or a stand-alone application (e.g., a downloadable application or “app” that runs on a smartphone, tablet, laptop, or desktop computer).

Such a convergence goes beyond the touch-and-feel advantages of brick-and-mortar stores, and enables the e-commerce shoppers to virtually try and/or customize a product to understand the interaction of the product with a virtual environment before committing to purchase. In addition, a shopper can perform a search for an object (in addition to searching for objects that have similar shape) and generate a collection of multiple alternatives products. A shopper who is considering multiple similar products can also stage all of these products in the same scene, thereby allowing the shopper to more easily compare these products (e.g., in terms of size, shape, and the degree to which the products match the décor of the staged environment). The benefits for e-commerce merchandise are increased sales and reduced cost of returns because visualizing the product within the virtual environment can increase the confidence of the shoppers in their purchase decisions. The benefits for the consumer are the ability to virtually customize, compare, and try a product before making a purchase decision.

Even under circumstances in which it is difficult or impossible to provide a user with a three-dimensional scene containing the product, embodiments of the present invention allow a seller to quickly and easily generate two-dimensional views of objects from a variety of angles and in a variety of contexts, by means of rendering techniques and without the time and expense associated with performing a photo shoot for each product. In addition, a seller may provide a variety of prefabricated 3D scenes in which the shopper can stage the products. In other words, some embodiments of the present invention allow the generation of multiple views of a product more quickly and economically than physically staging the actual product and photographing the product from multiple angles because a seller can merely perform a three-dimensional scan of the object and automatically generate the multiple views of the scanned object. Embodiments of the present invention also allow the rapid and economical generation of customized environments for particular customers or particular customer segments (e.g., depicting the same products in home, workshop, and office environments).

Therefore, aspects of embodiments of the present invention relate to a system and method for using an existing 3D virtual context or creating new 3D display virtual contexts to display products (e.g., 3D models of products) in a manner commensurate with various factors of the environment, either alone or in combination, such as the type, appearance, features, size, and usage of the products to enhance customer experience in an electronic marketplace, without the expense of physically staging a real object in a real environment.

Embodiments of the present invention allow an object to be placed into a typical environment of the object in real world. For instance, a painting may be shown on a wall of a room, furniture may be placed in a living room, a coffee maker may be shown on a kitchen counter, a wrist watch may be shown on a wrist, and so on. This differs significantly from a two-dimensional image of a product, which is typically static (e.g., a still image rather than a video or animation), and which is often shown on a featureless background (e.g., a white “blown-out” retail background).

Embodiments of the present invention also allow objects to be placed in conjunction with other related objects. For instance, a speaker system may be placed near a TV, or coffee table near a sofa, night stand near a bed, a lamp on the corner of room, or with other objects previously purchased, and so on. Objects are scaled in accordance with their real-world sizes, and therefore the physical relationships between objects can be understood from the arrangements. In the example of the speaker system, the speaker systems can vary in size, and the locations of indicator lights or infrared sensors can vary between TVs. In embodiments of the present invention, a shopper can virtually arrange a speaker system around a model of TV that the shopper already owns or is interested in to determine if the speakers will obstruct indicator lights and/or infrared sensors for the television remote control.

Embodiments of the present invention may also allow an object to be arranged in conjunction with other known objects. For instance, a floral centerpiece can be arranged on a table near a bottle of wine or with a particular color of tablecloth in order to evaluate the match between a centerpiece and a banquet arrangement. In addition, a small object can be depicted near other small objects to give a sense of size, such as near a smartphone, near a cat of average size, near a coin, etc.

Variants of the objects can be shown in context. For instance, a television available in three different sizes (e.g., with 32-inch, 42-inch, and 50-inch models) can be shown in the context of the shopper's living room in order to give a sense of the size of the television with respect to other furniture in the room. As another example, FIG. 3 is a depiction of an embodiment of the present invention in which different vases 32, speakers 34, and reading lights 36 are staged adjacent one another in order to depict their relative sizes, in a manner corresponding to how items would appear when arranged on the shelves of a physical (e.g., “brick and mortar”) store. The number of items shown on the virtual shelves 30 can also be used as an indication of current inventory (e.g., to encourage the consumer to buy the last one before the item goes out of stock). In addition to being generated through 3D scans, the 3D models of the products may also be provided from 3D models provided by the manufacturers or supplies of the products (e.g., CAD/CAM models) or generated syntactically (such as 3D characters in 3D video games).

Similarly, embodiments of the present invention can be used to stage products within environments that model the physical retail stores that these products would typically in, in order to simulate the experience of shopping in a brick and mortar retail store. For example, an online clothing retailer can stage the clothes that are available for sale in a virtual 3D environment of a store, with the clothes for sale being displayed as worn by mannequins, hanging on racks, and folded and resting on shelves and tables. As another example, an online electronics retailer can show different models of televisions side by side and arranged on shelves.

According to some embodiments of the present invention, the 3D models of the object may include movable parts to allow the objects to be reconfigured. In the coffee maker example described above, the opening of the lid of the coffee maker and/or the removable of the carafe can be shown with some motion in order to provide information about the clearances required around the object in various operating conditions. FIG. 4 illustrates one embodiment of the present invention in which a 3D model of a coffee maker is staged on a kitchen counter under a kitchen cabinet, where the motion of the opening of the lid is depicted using dotted lines. This allows a consumer to visualize whether there are sufficient clearances to operate the coffee maker if it is located under the cabinets.

As another example, the reading lamps 36 may be manipulated in order to illustrate the full range of motion of the heads of the lamps. As still another example, a model of a refrigerator may include the doors, drawers, and other sliding portions which can be animated within the context of the environment to show how those parts may interact with that environment (e.g., whether the door can fully open if placed at a particular distance from a wall and, even if the door cannot fully open, does it open enough to allow the drawers inside the refrigerator to slide in and out).

In some embodiments of the present invention, a user may define particular locations, hot spots, or favorite spots within a 3D environmental context: For instance, a user may typically want to view an object as it would appear in the corner of a room, on the user's coffee table, on user's kitchen counter, next to other appliances, etc. Aspects of embodiments of the present invention also allow a user to change the viewing angle on the model of the object within the contextualized environment.

### Scanning

Aspects of embodiments of the present invention relate to the use of three-dimensional (3D) scanning that uses a camera to collect data from different views of an ordinary object, then aligns and combines the data to create a 3D model of the shape and color (if available) of the object. In some contexts, the term ‘mapping’ is also used to refer to the process of capturing a space in 3D. Among the camera types used for scanning, one can use an ordinary color camera, a depth (or range) camera or a combination of depth and color camera. The latter is typically called RGB-D where RGB stands for the color image and D stands for the depth image (where each pixel encodes the depth (or distance) information of the scene.) The depth image can be obtained by different methods including geometric or electronic. Examples of geometric methods include passive or active stereo camera systems and structured light camera systems. Examples of electronic methods to capture depth image include Time of Flight (TOF), or general scanning or fixed LIDAR cameras.

Depending on the choice of the camera, different algorithms are used. A class of algorithms called Dense Tracking and Mapping in Real Time (DTAM) uses color clues for scanning and another class of algorithms called Simultaneous Localization and Mapping (SLAM) uses depth (or combination of depth and color) data. The scanning applications allow the user to freely move the camera around the object to capture all sides of the object. The underlying algorithm tracks to find the pose of the camera to align it with the object or consequently with partially reconstructed 3D model of the object. Additional details about 3D scanning systems are discussed below in the section “Scanner Systems.”

For example, a seller of an item can use three-dimensional scanning technology to scan the item to generate a three-dimensional model. The three-dimensional model of the item can then be staged within a three-dimensional virtual environment. In some instances, a shopper provides the three-dimensional virtual environment, which may be created by the shopper by performing a three-dimensional scan of a room or a portion of a room.

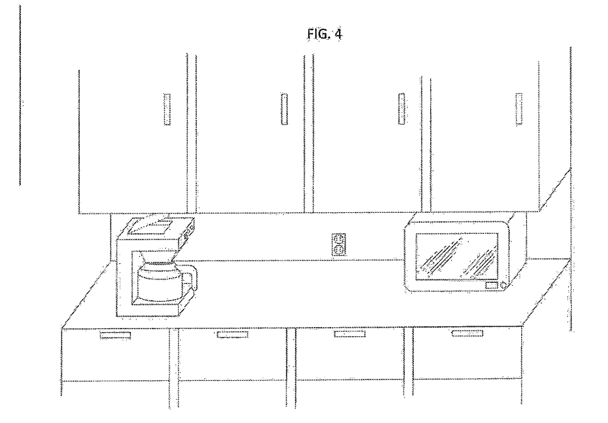

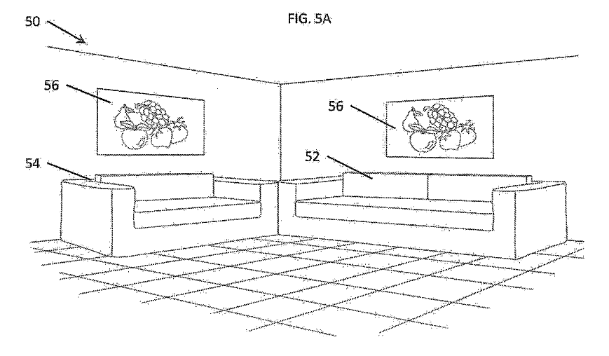

FIG. 5A is a depiction of a user's living room as generated by performing a three-dimensional scan of the living room according to one embodiment of the present invention. Referring to FIG. 5A, a consumer may have constructed a three-dimensional representation 50 of his or her living room, which includes a sofa 52 and a loveseat 54. This three-dimensional representation may be generated using a 3D scanning device. The consumer may be considering the addition of a framed picture 56 to the living room, but uncertain as to whether the framed picture would be better suited above the sofa or the loveseat, or an appropriate size for the frame. As such, embodiments of the present invention allow the generation of scenes in which a product, such as the framed picture 56, is staged in a three-dimensional representation of the customer's environment 50, thereby allowing the consumer to easily appreciate the size and shape of the product and its effect on the room.

FIG. 5B is a depiction of a user's dining room as generated by performing a three-dimensional scan of the living room according to one embodiment of the present invention. Referring to FIG. 5B, as another example, a consumer may consider different types of light fixtures 58 for a dining room. The size, shape, and height of the dining table 59 can affect the types and sizes of lighting fixtures that would be appropriate for the room. As such, embodiments of the present invention allow the staging of the light fixtures 58 in a three-dimensional virtual representation 57 of the dining room, thereby allowing the consumer to more easily visualize how the light fixture will appear when actually installed in the dining room.

In some embodiments of the present invention, the 3D models may also include one or more light sources. By incorporating the sources of light of the object within the 3D model, embodiments of the present invention can further simulate the effect of the object on the lighting of the environment. Continuing the example above of FIG. 5B, the 3D model of the light fixture may also include one or more light sources which represent one or more light bulbs within the light fixture. As such, embodiments of the present invention can render a simulation of how the dining room would look with the light bulbs in the light fixture turned on, including the rendering of shadows and reflections from surfaces within the room (e.g., the dining table, the walls, ceiling and floor, and the fixture itself). Furthermore, in some embodiments of the present invention, characteristics of the light emitted from these sources can be modified to simulate the use of different types of lights (e.g., different wattages, different color temperatures, different technologies such as incandescent, fluorescent, or light emitting diode bulbs, the effects of using a dimmer switch, and the like). These information about the light sources within the 3D model and the settings of those light sources may be included in metadata associated with the 3D model. (Similarly, settings about the light sources of the virtual 3D environment may be included within the metadata associated with the virtual 3D environment.)

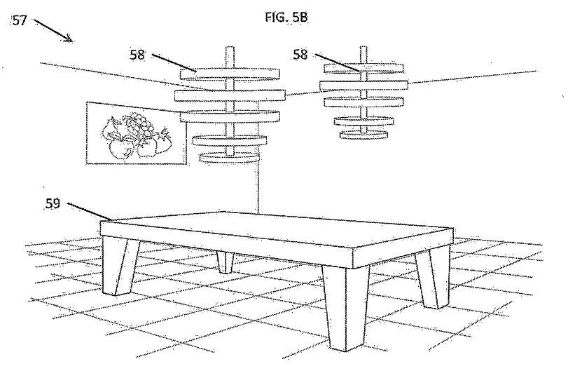

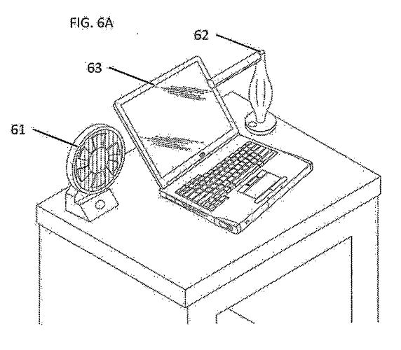

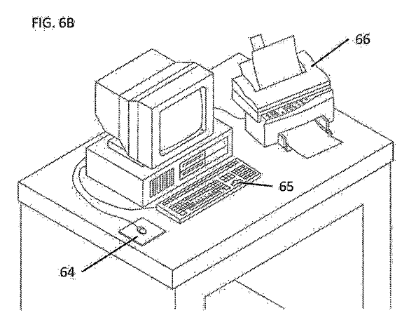

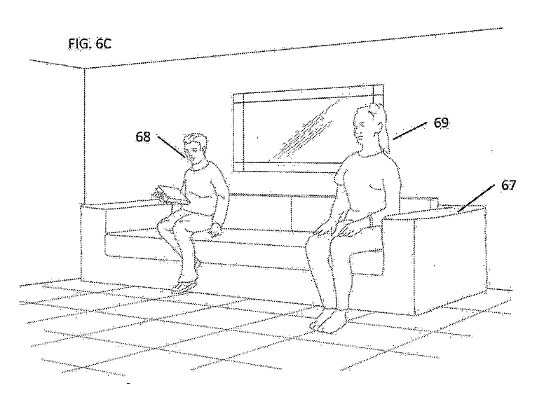

According to another aspect of embodiments of the present invention, it may be difficult to understand the size of a product that is for sale. FIGS. 6A, 6B, and 6C are depictions of the staging, according to embodiments of the present invention, of products in scenes with items of known size. As such, as shown in FIGS. 6A and 6B, some embodiments of the present invention relate to staging the product or products (e.g., a fan 61 and a reading lamp 62 of FIG. 6A or a small computer mouse 64 of FIG. 6B) adjacent to an object of well-known size (e.g., a laptop computer 63 of FIG. 6A or a computer keyboard 65 and printer 66 of FIG. 6B).

As still another example, the sizes of objects can be shown in relation to human figures. For example, the size of a couch 67 can be depicted by adding three-dimensional models of people 68 and 69 of different sizes to the scene (e.g., arrange them to be sitting on the couch), thereby providing information about whether, for example, the feet of a shorter person 68 may not reach the floor when sitting on the couch, as shown in FIG. 6C.

One important visual property for generating realistic computer renderings of an object is its surface reflectance. For instance, a leather shoe can be finished with a typical shiny leather surface, or in a more matte suede (or inside-out) finish. A suede-like surface diffuses the light in many directions and it is said, technically, to have Lambertian surface property. A shiny leather-like surface has a more reflective surface and its appearance depends on how the light is reflected from the surface to the viewer's eye.

During the 3D scan of an object, it is possible to capture the surface Bidirectional Reflectance Distribution Function (BRDF) properties, which encodes the surface reflectance properties of the objects. Another embodiment of the present invention, during the staging of the scanned object, the normal and BRDF (if available) of the object surface can be used to display the object on natural and artificial lighting condition. See, e.g., U.S. Provisional Patent Application No. 62/375,350 “A Method and System for Simultaneous 3D Scanning and Capturing BRDF with Hand-held 3D Scanner” filed in the United States Patent and Trademark Office on Aug. 15, 2016 and U.S. patent application Ser. No. 15/678,075 “System and Method for Three-Dimensional Scanning and for Capturing a Bidirectional Reflectance Distribution Function,” filed in the United States Patent and Trademark Office on Aug. 15, 2017, the entire disclosures of which are incorporated by reference herein.

By including surface reflectance properties of the object in the 3D models of the object, the system can depict the interaction of the sources of light in the virtual 3D environment with the materials of the objects, thereby allowing for a more accurate depiction of these objects in the 3D environments. As such, the object can be shown in an environment under various lighting conditions. For instance, the centerpiece described above can be shown in daytime, at night, indoors, outdoors, under light sources having different color temperature (e.g., candlelight, incandescent lighting, halogen lighting, LED lighting, fluorescent lighting, flash photography, etc.), and with light sources from different angles (e.g., if the object is placed next to a window). When the 3D object model includes texture information, such as a bidirectional reflectance distribution function (BRDF), the 3D object model can be lighted in accordance with the light sources present in the scene.

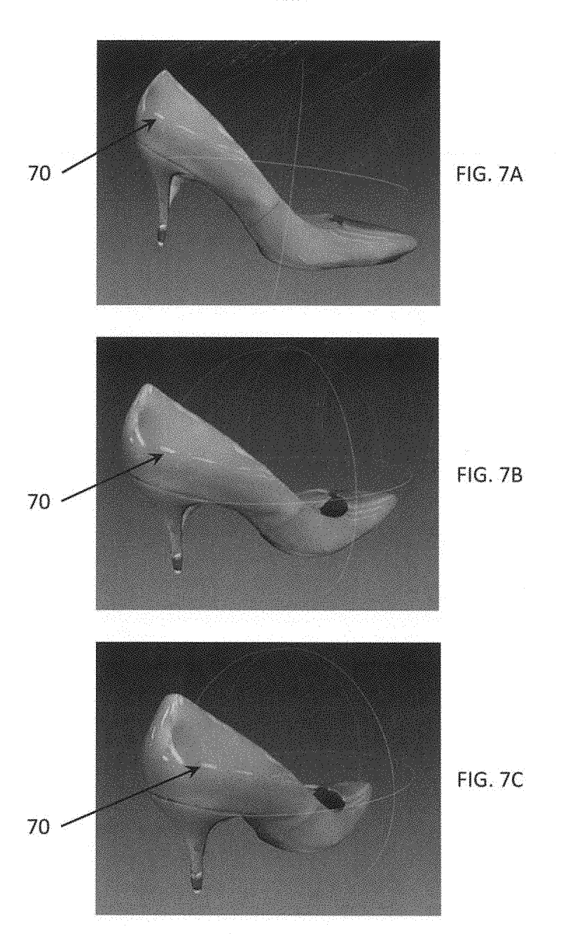

Referring to FIGS. 7A, 7B, 7C, 8A, 8B, 9A, and 9B, relighting capabilities enable the merchant to exhibit the object in more natural setting for the consumer. FIGS. 7A, 7B, and 7C show one of the artifacts of 3D object scanning where the lighting conditions during the scanning of the 3D object are incorporated (“burned” or “baked”) into the 3D model. In particular, FIGS. 7A, 7B, and 7C show different views of the same glossy shoe rotated to different positions. In each of the images, the same specular highlight 70 is seen at the same position on the shoe itself, irrespective of the change in position of the shoe. This is because the specular highlight is incorporated into the texture of the shoe (e.g., the texture associated with the mode treats that portion of the shoe as effectively being fully saturated or white). This results in an unnatural appearance of the shoe, especially if the 3D model of the shoe is placed into an environment with lighting conditions that are inconsistent with the specular highlights that are baked into the model.

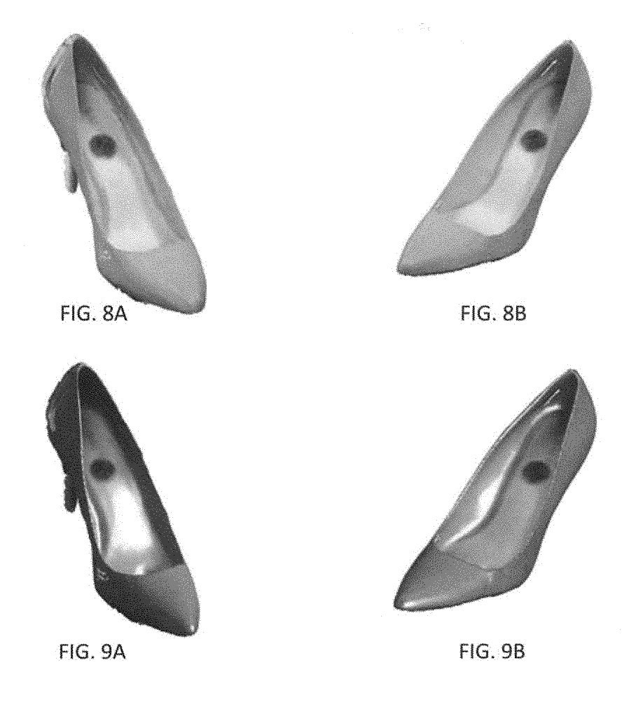

FIGS. 8A, 8B, 9A, and 9B are renderings of a 3D model of a shoe under different lighting conditions, where modifying the lighting causes the shoe to be rendered differently under different lighting conditions in accordance with a bidirectional reflectance distribution function (BRDF), or an approximation thereof, stored in association with the model (e.g., included in metadata or texture information of the 3D model). As such, aspects of embodiments of the present invention allow the relighting of the model based on the lighting conditions of the virtual 3D environment (e.g., locations and color temperature of the light sources, and light reflected or refracted from other objects in the scene) because, in the minimum, the surface normals of the 3D model are computable and some default assumptions can be made about the surface reflectance properties of the object. Furthermore, if a good estimate of the true BRDF properties of the model is also captured by the 3D scanning process, the model can be relit even with higher fidelity, as if the consumer was in actual possession of the merchandise, thereby improving the consumer's confidence in whether or not the merchandise or product would be suitable in the environments in which the consumer intends to place or use the product.

Furthermore, combining information about the direction of the one or more sources of illumination in the environment, the 3D geometry of the model added to the environment, and a 3D model of the staging environment itself enables realistic rendering of shadows cast by the object onto the environment, and cast by the environment onto the object. For example, a consumer may purchase a painting that appears very nice in under studio lighting, but find that, once they bring the painting home, the lighting conditions of the room at home completely changes the appearance of the painting. For instance, the shadow of the frame from a nearby ceiling light may create two lighting regions on the painting that are not desirable. However, using the methods described in the present disclosure, the merchant can stage the painting in a simulation of the consumer's environment (e.g., the customer's living room) to promote the product and also to illustrate the need for proper lighting to increase post-sale consumer satisfaction.

Scanner Systems

Generally, scanner systems include hardware devices that include a sensor, such as a camera, that collects data from a scene. The scanner systems may include a computer processor or other processing hardware for generating depth images and/or three-dimensional (3D) models of the scene from the data collected by the sensor.

The sensor of a scanner system may be, for example one of a variety of different types of cameras including: an ordinary color camera; a depth (or range) camera; or a combination of depth and color camera. The latter is typically called RGB-D where RGB stands for the color image and D stands for the depth image (where each pixel encodes the depth (or distance) information of the scene.) The depth image can be obtained by different methods including geometric or electronic methods. A depth image may be represented as a point cloud or may be converted into a point cloud. Examples of geometric methods include passive or active stereo camera systems and structured light camera systems. Examples of electronic methods to capture depth images include Time of Flight (TOF), or general scanning or fixed LIDAR cameras.

Depending on the type of camera, different algorithms may be used to generate depth images from the data captured by the camera. A class of algorithms called Dense Tracking and Mapping in Real Time (DTAM) uses color cues in the captured images, while another class of algorithms referred to as Simultaneous Localization and Mapping (SLAM) uses depth (or a combination of depth and color) data, while yet another class of algorithms are based on the Iterative Closest Point (ICP) and its derivatives.

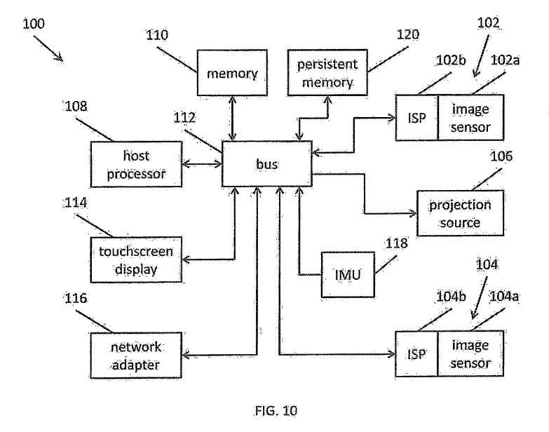

As described in more detail below with respect to FIG. 10, at least some depth camera systems allow a user to freely move the camera around the object to capture all sides of the object. The underlying algorithm for generating the combined depth image may track and/or infer the pose of the camera with respect to the object in order to align the captured data with the object or with a partially constructed 3D model of the object. One example of a system and method for scanning three-dimensional objects is described in “Systems and methods for scanning three-dimensional objects” U.S. patent application Ser. No. 15/630,715, filed in the United States Patent and Trademark Office on Jun. 22, 2017, the entire disclosure of which is incorporated herein by reference.

In some embodiments of the present invention, the construction of the depth image or 3D model is performed locally by the scanner itself. It other embodiments, the processing is performed by one or more local or remote servers, which may receive data from the scanner over a wired or wireless connection (e.g., an Ethernet network connection, a USB connection, a cellular data connection, a local wireless network connection, and a Bluetooth connection). Similarly, in embodiments of the present invention, various operations associated with performing operations associated with aspects of the present invention, including the operations described with respect to FIGS. 2A and 2B such as obtaining the three-dimensional environment, loading a three-dimensional model, staging the 3D model in the 3D environment, rendering the staged model, and the like, may be implemented either on the host processor 108 or on one or more local or remote servers.

As a more specific example, the scanner may be a hand-held 3D scanner. Such hand-held 3D scanners may include a depth camera (a camera that computes the distance of the surface elements imaged by each pixel) together with software that can register multiple depth images of the same surface to create a 3D representation of a possibly large surface or of a complete object. Users of hand-held 3D scanners need to move it to different positions around the object and orient it so that all points in the object's surface are covered (e.g., the surfaces are seen in at least one depth image taken by the scanner). In addition, it is important that each surface patch receive a high enough density of depth measurements (where each pixel of the depth camera provides one such depth measurement). The density of depth measurements depends on the distance from which the surface patch has been viewed by a camera, as well as on the angle or slant of the surface with respect to the viewing direction or optical axis of the depth camera.

FIG. 10 is a block diagram of a scanning system as a stereo depth camera system according to one embodiment of the present invention.

The scanning system 100 shown in FIG. 10 includes a first camera 102, a second camera 104, a projection source 106 (or illumination source or active projection system), and a host processor 108 and memory 110, wherein the host processor may be, for example, a graphics processing unit (GPU), a more general purpose processor (CPU), an appropriately configured field programmable gate array (FPGA), or an application specific integrated circuit (ASIC). The first camera 102 and the second camera 104 may be rigidly attached, e.g., on a frame, such that their relative positions and orientations are substantially fixed. The first camera 102 and the second camera 104 may be referred to together as a “depth camera.” The first camera 102 and the second camera 104 include corresponding image sensors 102a and 104a, and may also include corresponding image signal processors (ISP) 102b and 104b. The various components may communicate with one another over a system bus 112. The scanning system 100 may include additional components such as a display 114 to allow the device to display images, a network adapter 116 to communicate with other devices, an inertial measurement unit (IMU) 118 such as a gyroscope to detect acceleration of the scanning system 100 (e.g., detecting the direction of gravity to determine orientation and detecting movements to detect position changes), and persistent memory 120 such as NAND flash memory for storing data collected and processed by the scanning system 100. The IMU 118 may be of the type commonly found in many modern smartphones. The image capture system may also include other communication components, such as a universal serial bus (USB) interface controller.

In some embodiments, the image sensors 102a and 104a of the cameras 102 and 104 are RGB-IR image sensors. Image sensors that are capable of detecting visible light (e.g., red-green-blue, or RGB) and invisible light (e.g., infrared or IR) information may be, for example, charged coupled device (CCD) or complementary metal oxide semiconductor (CMOS) sensors. Generally, a conventional RGB camera sensor includes pixels arranged in a “Bayer layout” or “RGBG layout,” which is 50% green, 25% red, and 25% blue. Band pass filters (or “micro filters”) are placed in front of individual photodiodes (e.g., between the photodiode and the optics associated with the camera) for each of the green, red, and blue wavelengths in accordance with the Bayer layout. Generally, a conventional RGB camera sensor also includes an infrared (IR) filter or IR cut-off filter (formed, e.g., as part of the lens or as a coating on the entire image sensor chip) which further blocks signals in an IR portion of electromagnetic spectrum.

An RGB-IR sensor is substantially similar to a conventional RGB sensor, but may include different color filters. For example, in an RGB-IR sensor, one of the green filters in every group of four photodiodes is replaced with an IR band-pass filter (or micro filter) to create a layout that is 25% green, 25% red, 25% blue, and 25% infrared, where the infrared pixels are intermingled among the visible light pixels. In addition, the IR cut-off filter may be omitted from the RGB-IR sensor, the IR cut-off filter may be located only over the pixels that detect red, green, and blue light, or the IR filter can be designed to pass visible light as well as light in a particular wavelength interval (e.g., 840-860 nm). An image sensor capable of capturing light in multiple portions or bands or spectral bands of the electromagnetic spectrum (e.g., red, blue, green, and infrared light) will be referred to herein as a “multi-channel” image sensor.

In some embodiments of the present invention, the image sensors 102a and 104a are conventional visible light sensors. In some embodiments of the present invention, the system includes one or more visible light cameras (e.g., RGB cameras) and, separately, one or more invisible light cameras (e.g., infrared cameras, where an IR band-pass filter is located across all over the pixels). In other embodiments of the present invention, the image sensors 102a and 104a are infrared (IR) light sensors.

Generally speaking, a stereoscopic depth camera system includes at least two cameras that are spaced apart from each other and rigidly mounted to a shared structure such as a rigid frame. The cameras are oriented in substantially the same direction (e.g., the optical axes of the cameras may be substantially parallel) and have overlapping fields of view. These individual cameras can be implemented using, for example, a complementary metal oxide semiconductor (CMOS) or a charge coupled device (CCD) image sensor with an optical system (e.g., including one or more lenses) configured to direct or focus light onto the image sensor. The optical system can determine the field of view of the camera, e.g., based on whether the optical system is implements a “wide angle” lens, a “telephoto” lens, or something in between.

In the following discussion, the image acquisition system of the depth camera system may be referred to as having at least two cameras, which may be referred to as a “master” camera and one or more “slave” cameras. Generally speaking, the estimated depth or disparity maps computed from the point of view of the master camera, but any of the cameras may be used as the master camera. As used herein, terms such as master/slave, left/right, above/below, first/second, and CAM1/CAM2 are used interchangeably unless noted. In other words, any one of the cameras may be master or a slave camera, and considerations for a camera on a left side with respect to a camera on its right may also apply, by symmetry, in the other direction. In addition, while the considerations presented below may be valid for various numbers of cameras, for the sake of convenience, they will generally be described in the context of a system that includes two cameras. For example, a depth camera system may include three cameras. In such systems, two of the cameras may be invisible light (infrared) cameras and the third camera may be a visible light (e.g., a red/blue/green color camera) camera. All three cameras may be optically registered (e.g., calibrated) with respect to one another. One example of a depth camera system including three cameras is described in U.S. patent application Ser. No. 15/147,879 “Depth Perceptive Trinocular Camera System” filed in the United States Patent and Trademark Office on May 5, 2016, the entire disclosure of which is incorporated by reference herein.

The memory 110 and/or the persistent memory 120 may store instructions that, when executed by the host processor 108, cause the host processor to perform various functions. In particular, the instructions may cause the host processor to read and write data to and from the memory 110 and the persistent memory 120, and to send commands to, and receive data from, the various other components of the scanning system 100, including the cameras 102 and 104, the projection source 106, the display 114, the network adapter 116, and the inertial measurement unit 118.

The host processor 108 may be configured to load instructions from the persistent memory 120 into the memory 110 for execution. For example, the persistent memory 120 may store an operating system and device drivers for communicating with the various other components of the scanning system 100, including the cameras 102 and 104, the projection source 106, the display 114, the network adapter 116, and the inertial measurement unit 118.

The memory 110 and/or the persistent memory 112 may also store instructions that, when executed by the host processor 108, cause the host processor to generate a 3D point cloud from the images captured by the cameras 102 and 104, to execute a 3D model construction engine, and to perform texture mapping. The persistent memory may also store instructions that, when executed by the processor, cause the processor to compute a bidirectional reflectance distribution function (BRDF) for various patches or portions of the constructed 3D model, also based on the images captured by the cameras 102 and 104. The resulting 3D model and associated data, such as the BRDF may be stored in the persistent memory 120 and/or transmitted using the network adapter 116 or other wired or wireless communication device (e.g., a USB controller or a Bluetooth controller).

To detect the depth of a feature in a scene imaged by the cameras, the instructions for generating the 3D point cloud and the 3D model and for performing texture mapping are executed by the depth camera system 100 determines the pixel location of the feature in each of the images captured by the cameras. The distance between the features in the two images is referred to as the disparity, which is inversely related to the distance or depth of the object. (This is the effect when comparing how much an object “shifts” when viewing the object with one eye at a time—the size of the shift depends on how far the object is from the viewer's eyes, where closer objects make a larger shift and farther objects make a smaller shift and objects in the distance may have little to no detectable shift.) Techniques for computing depth using disparity are described, for example, in R. Szeliski. “Computer Vision: Algorithms and Applications”, Springer, 2010 pp. 467 et seq.

The magnitude of the disparity between the master and slave cameras depends on physical characteristics of the depth camera system, such as the pixel resolution of cameras, distance between the cameras and the fields of view of the cameras. Therefore, to generate accurate depth measurements, the depth camera system (or depth perceptive depth camera system) is calibrated based on these physical characteristics.

In some depth camera systems, the cameras may be arranged such that horizontal rows of the pixels of the image sensors of the cameras are substantially parallel. Image rectification techniques can be used to accommodate distortions to the images due to the shapes of the lenses of the cameras and variations of the orientations of the cameras.

In more detail, camera calibration information can provide information to rectify input images so that epipolar lines of the equivalent camera system are aligned with the scanlines of the rectified image. In such a case, a 3D point in the scene projects onto the same scanline index in the master and in the slave image. Let uₘ and uₛ be the coordinates on the scanline of the image of the same 3D point p in the master and slave equivalent cameras, respectively, where in each camera these coordinates refer to an axis system centered at the principal point (the intersection of the optical axis with the focal plane) and with horizontal axis parallel to the scanlines of the rectified image. The difference uₛ−uₘ is called disparity and denoted by d; it is inversely proportional to the orthogonal distance of the 3D point with respect to the rectified cameras (that is, the length of the orthogonal projection of the point onto the optical axis of either camera).

Stereoscopic algorithms exploit this property of the disparity. These algorithms achieve 3D reconstruction by matching points (or features) detected in the left and right views, which is equivalent to estimating disparities. Block matching (BM) is a commonly used stereoscopic algorithm. Given a pixel in the master camera image, the algorithm computes the costs to match this pixel to any other pixel in the slave camera image. This cost function is defined as the dissimilarity between the image content within a small window surrounding the pixel in the master image and the pixel in the slave image. The optimal disparity at point is finally estimated as the argument of the minimum matching cost. This procedure is commonly addressed as Winner-Takes-All (WTA). These techniques are described in more detail, for example, in R. Szeliski. “Computer Vision: Algorithms and Applications”, Springer, 2010. Since stereo algorithms like BM rely on appearance similarity, disparity computation becomes challenging if more than one pixel in the slave image have the same local appearance, as all of these pixels may be similar to the same pixel in the master image, resulting in ambiguous disparity estimation. A typical situation in which this may occur is when visualizing a scene with constant brightness, such as a flat wall.

Methods exist that provide additional illumination by projecting a pattern that is designed to improve or optimize the performance of block matching algorithm that can capture small 3D details such as the one described in U.S. Pat. No. 9,392,262 “System and Method for 3D Reconstruction Using Multiple Multi-Channel Cameras,” issued on Jul. 12, 2016, the entire disclosure of which is incorporated herein by reference. Another approach projects a pattern that is purely used to provide a texture to the scene and particularly improve the depth estimation of texture-less regions by disambiguating portions of the scene that would otherwise appear the same.

The projection source 106 according to embodiments of the present invention may be configured to emit visible light (e.g., light within the spectrum visible to humans and/or other animals) or invisible light (e.g., infrared light) toward the scene imaged by the cameras 102 and 104. In other words, the projection source may have an optical axis substantially parallel to the optical axes of the cameras 102 and 104 and may be configured to emit light in the direction of the fields of view of the cameras 102 and 104. In some embodiments, the projection source 106 may include multiple separate illuminators, each having an optical axis spaced apart from the optical axis (or axes) of the other illuminator (or illuminators), and spaced apart from the optical axes of the cameras 102 and 104.

An invisible light projection source may be better suited to for situations where the subjects are people (such as in a videoconferencing system) because invisible light would not interfere with the subject's ability to see, whereas a visible light projection source may shine uncomfortably into the subject's eyes or may undesirably affect the experience by adding patterns to the scene. Examples of systems that include invisible light projection sources are described, for example, in U.S. patent application Ser. No. 14/788,078 “Systems and Methods for Multi-Channel Imaging Based on Multiple Exposure Settings,” filed in the United States Patent and Trademark Office on Jun. 30, 2015, the entire disclosure of which is herein incorporated by reference.

Active projection sources can also be classified as projecting static patterns, e.g., patterns that do not change over time, and dynamic patterns, e.g., patterns that do change over time. In both cases, one aspect of the pattern is the illumination level of the projected pattern. This may be relevant because it can influence the depth dynamic range of the depth camera system. For example, if the optical illumination is at a high level, then depth measurements can be made of distant objects (e.g., to overcome the diminishing of the optical illumination over the distance to the object, by a factor proportional to the inverse square of the distance) and under bright ambient light conditions. However, a high optical illumination level may cause saturation of parts of the scene that are close-up. On the other hand, a low optical illumination level can allow the measurement of close objects, but not distant objects.

In some circumstances, the depth camera system includes two components: a detachable scanning component and a display component. In some embodiments, the display component is a computer system, such as a smartphone, a tablet, a personal digital assistant, or other similar systems. Scanning systems using separable scanning and display components are described in more detail in, for example, U.S. patent application Ser. No. 15/382,210 “3D Scanning Apparatus Including Scanning Sensor Detachable from Screen” filed in the United States Patent and Trademark Office on Dec. 16, 2016, the entire disclosure of which is incorporated by reference.

Although embodiments of the present invention are described herein with respect to stereo depth camera systems, embodiments of the present invention are not limited thereto and may also be used with other depth camera systems such as structured light time of flight cameras and LIDAR cameras.

Depending on the choice of camera, different techniques may be used to generate the 3D model. For example, Dense Tracking and Mapping in Real Time (DTAM) uses color cues for scanning and Simultaneous Localization and Mapping uses depth data (or a combination of depth and color data) to generate the 3D model.

In some embodiments of the present invention, the memory 110 and/or the persistent memory 112 may also store instructions that, when executed by the host processor 108, cause the host processor to execute a rendering engine. In other embodiments of the present invention, the rendering engine may be implemented by a different processor (e.g., implemented by a processor of a computer system connected to the scanning system 100 via, for example, the network adapter 116 or a local wired or wireless connection such USB or Bluetooth). The rendering engine may be configured to render an image (e.g., a two-dimensional image) of the 3D model generated by the scanning system 100.

While embodiments of the present invention are described above in the context of e-commerce and the staging of products for sale within virtual three-dimensional environments, embodiments of the present invention are not limited thereto.

In some embodiments of the present invention, the three-dimensional environment may mimic the physical appearance of a brick and mortar store. In the case of a clothing retailer, for example, some featured items may be displayed on mannequins (e.g., three-dimensional scans of mannequins) in a central part of the store, while other pieces of clothing may be grouped and displayed on virtual hangars by category (e.g., shirts in a separate area from jackets). This spatial contextualization of products may make it more comfortable for users to browse through product catalogs than reading through textual lists.

In some embodiments of the present invention, the synthetic three-dimensional scene construction is used to provide an environment for multiple users to import scanned 3D models. The multiple users can then collaborate on three-dimensional mashups, creating synthetic three-dimensional spaces for social interactions using realistic scanned objects. These environments may be used for, for example, gaming and/or the sharing of arts and crafts and other creative works.

In some embodiments, the environments for the scenes may be official game content, such as a part of a three-dimensional “map” for a three-dimensional game such as Counter-Strike®. Users can supply personally scanned objects for use within the official game environment.

What is claimed is:

1. A method for staging a three-dimensional model of a product for sale comprising:
obtaining, by a processor, a three-dimensional environment in which to stage the three-dimensional model, the three-dimensional environment comprising environment scale data;
loading, by the processor, the three-dimensional model of the product for sale from a collection of models of products for sale by a retailer, the three-dimensional model comprising model scale data;
matching, by the processor, the model scale data and the environment scale data;
staging, by the processor, the three-dimensional model in the three-dimensional environment in accordance with the matched model and environment scale data to generate a three-dimensional scene;
rendering, by the processor, the three-dimensional scene; and
displaying, by the processor, the rendered three-dimensional scene.

2. The method of claim 1, wherein the three-dimensional model comprises at least one light source, and
wherein the rendering the three-dimensional scene comprises lighting at least one surface of the three-dimensional environment in accordance with light emitted from the at least one light source of the three-dimensional model.

3. The method of claim 1, wherein the three-dimensional model comprises metadata comprising staging information of the product for sale, and
wherein the staging the three-dimensional model comprises deforming at least one surface in the three-dimensional scene in accordance with the staging information and in accordance with an interaction between the three-dimensional model and the three-dimensional environment or another three-dimensional model in the three-dimensional scene.

4. The method of claim 1, wherein the three-dimensional model comprises metadata comprising rendering information of the product for sale, the rendering information comprising a plurality of bidirectional reflectance distribution function (BRDF) properties, and
wherein the method further comprises lighting, by the processor, the three-dimensional scene in accordance with the bidirectional reflectance distribution function properties of the model within the scene to generate a lit and staged three-dimensional scene.

5. The method of claim 4, further comprising:
generating a plurality of two-dimensional images based on the lit and staged three-dimensional scene; and
outputting the two-dimensional images.

6. The method of claim 1, wherein the three-dimensional model is generated by a three-dimensional scanner comprising:
a first infrared camera;
a second infrared camera having a field of view overlapping the first infrared camera; and
a color camera having a field of view overlapping the first infrared camera and the second infrared camera.

7. The method of claim 1, wherein the three-dimensional environment is generated by a three-dimensional scanner comprising:
a first infrared camera;
a second infrared camera having a field of view overlapping the first infrared camera; and
a color camera having a field of view overlapping the first infrared camera and the second infrared camera.

8. The method of claim 7, wherein the three-dimensional environment is generated by the three-dimensional scanner by:
capturing an initial depth image of a physical environment with the three-dimensional scanner in a first pose;
generating a three-dimensional model of the physical environment from the initial depth image;
capturing an additional depth image of the physical environment with the three-dimensional scanner in a second pose different from the first pose;
updating the three-dimensional model of the physical environment with the additional depth image; and
outputting the three-dimensional model of the physical environment as the three-dimensional environment.

9. The method of claim 7, wherein the rendering the three-dimensional scene comprises rendering the staged three-dimensional model and compositing the rendered three-dimensional model with a view of the scene captured by the color camera of the three-dimensional scanner.

10. The method of claim 1, wherein the obtaining the three-dimensional environment comprises:
identifying model metadata associated with the three-dimensional model;
comparing the model metadata with environment metadata associated with a plurality of three-dimensional environments; and
identifying one of the three-dimensional environments having environment metadata matching the model metadata.

11. The method of claim 1, further comprising:
identifying model metadata associated with the three-dimensional model;
comparing the model metadata with object metadata associated with a plurality of object models of the collection of models of products for sale by the retailer;
identifying one of the object models having object metadata matching the model metadata; and
staging the one of the object models in the three-dimensional environment.

12. The method of claim 1, wherein the three-dimensional model is associated with object metadata comprising one or more staging rules, and
wherein the staging the one of the object models in the three-dimensional environment comprises arranging the object within the staging rules.

13. The method of claim 1, wherein the model comprises one or more movable components,
wherein the staging comprises modifying the positions of the one or more movable components of the model, and
wherein the method further comprises detecting a collision between:
a portion of at least one of the one or more movable components of the model at at least one of the modified positions; and
a surface of the three-dimensional scene.

14. The method of claim 1, wherein the three-dimensional environment is a model of a virtual store.

15. A system comprising:
a processor;
a display device coupled to the processor; and
memory storing instructions that, when executed by the processor, cause the processor to:
obtain a three-dimensional environment in which to stage a three-dimensional model of a product for sale, the three-dimensional environment comprising environment scale data;
load the three-dimensional model of the product for sale from a collection of models of products for sale by a retailer, the three-dimensional model comprising model scale data;
match the model scale data and the environment scale data;
stage the three-dimensional model in the three-dimensional environment in accordance with the matched model and environment scale data to generate a three-dimensional scene;
render the three-dimensional scene; and
display the rendered three-dimensional scene on the display device.

16. The system of claim 15, wherein the three-dimensional model comprises at least one light source, and
wherein the memory further stores instructions that, when executed by the processor, cause the processor to render the three-dimensional scene by lighting at least one surface of the three-dimensional environment in accordance with light emitted from the at least one light source of the three-dimensional model.

17. The system of claim 15, wherein the three-dimensional model comprises metadata including staging information of the product for sale, and
wherein the memory further stores instructions that, when executed by the processor, cause the processor to stage the three-dimensional model by deforming at least one surface in the three-dimensional scene in accordance with the staging information and in accordance with an interaction between the three-dimensional model and the three-dimensional environment or another three-dimensional model in the three-dimensional scene.

18. The system of claim 15, wherein the three-dimensional model comprises metadata including rendering information of the product for sale, the rendering information comprising a plurality of bidirectional reflectance distribution function (BRDF) properties, and
wherein the memory further stores instructions that, when executed by the processor, cause the processor to light the three-dimensional scene in accordance with the bidirectional reflectance distribution function properties of the model within the scene to generate a lit and staged three-dimensional scene.

19. The system of claim 15, wherein the system further comprises a three-dimensional scanner coupled to the processor, the three-dimensional scanner comprising:
a first infrared camera;
a second infrared camera having a field of view overlapping the first infrared camera; and
a color camera having a field of view overlapping the first infrared camera and the second infrared camera.

20. The system of claim 19, wherein the memory further stores instructions that, when executed by the processor, cause the processor to generate the three-dimensional environment by controlling the three-dimensional scanner to:
capture an initial depth image of a physical environment with the three-dimensional scanner in a first pose;
generate a three-dimensional model of the physical environment from the initial depth image;
capture an additional depth image of the physical environment with the three-dimensional scanner in a second pose different from the first pose;
update the three-dimensional model of the physical environment with the additional depth image; and
output the three-dimensional model of the physical environment as the three-dimensional environment.

21. The system of claim 19, wherein the memory further stores instructions that, when executed by the processor, cause the processor to render the three-dimensional scene by rendering the staged three-dimensional model and compositing the rendered three-dimensional model with a view of the scene captured by the color camera of the three-dimensional scanner.

22. The system of claim 19, wherein the model comprises one or more movable components,
wherein the staging comprises modifying the positions of the one or more movable components of the model, and
wherein the memory further stores instructions that, when executed by the processor, cause the processor to detect a collision between:
a portion of at least one of the one or more movable components of the model at at least one of the modified positions; and
a surface of the three-dimensional scene.

23. A method for staging a three-dimensional model of a product for sale, the method comprising:
obtaining, by a processor, a virtual environment in which to stage the three-dimensional model;
loading, by the processor, the three-dimensional model from a collection of models of products for sale by a retailer, the three-dimensional model comprising model scale data;
staging, by the processor, the three-dimensional model in the virtual environment to generate a staged virtual scene;
rendering, by the processor, the staged virtual scene; and
displaying, by the processor, the rendered staged virtual scene.

24. The method of claim 23, further comprising capturing a two-dimensional view a physical environment, wherein the virtual environment is computed from the two-dimensional view of the physical environment.

25. The method of claim 24, wherein the rendering the staged virtual scene comprises rendering the three-dimensional model in the virtual environment, and
wherein the method further comprises:
compositing the rendered three-dimensional model onto the two-dimensional view of the physical environment; and
displaying the composited three-dimensional model onto the two-dimensional view.
